(19) United States
(12) Patent Application Publication
(10) Pub. No.: US 2008/0163305 A1
(43) Pub. Date: Jul. 3, 2008

(54) System and Method for Customizing Programming Reminders

(76) Inventors: Carolynn Rae Johnson, Indianapolis, IN (US); Darrel Wayne Randall, Danville, IN (US)

Correspondence Address: Joseph J Laks;Thomson Licensing Inc, Patent Operations, P O BOx 5312, Princeton, NJ, 08543-5312, US

(21) Appl. No.: 10/591,376

(22) PCT Filed: Feb. 25, 2005
(86) PCT No.: PCT/US2005/006249

§ 371 Date: Aug. 31, 2006

Related U.S. Application Data
(60) Provisional application No. 60/551,584, filed on Mar. 9, 2004.

(51) Int. Cl. G06F 3/00

(52) U.S. Cl. 725/58

(57) ABSTRACT

A system and method for permitting users to control and customize program reminders for reminding the user of desired upcoming television programming event(s) is disclosed. A reminder customizer is provided having reminder options which permit users to control on which device(s) a reminder is desired to appear.

### TECHNICAL FIELD OF THE INVENTION

The present invention generally relates to television systems and, more particularly, to a system and method of allowing users to control and customize a reminder feature in conjunction with a television system for reminding the user of desired upcoming programming event(s).

### BACKGROUND OF THE INVENTION

A wide range of television services, including satellite television systems, have become commonplace today. In the case of satellite television, the problems of range and distortion are solved by transmitting broadcast signals from satellites orbiting the Earth. Satellite television systems transmit and receive radio signals using specialized antennas (satellite dishes) and most satellite TV customers get their programming through a direct broadcast satellite (DBS) provider, such as DirecTV™ or the Dish Network™. About 1 in 10 households currently subscribes to a satellite television service, a number expected to double within the next couple of years.

Unlike earlier satellite programming, the provider's broadcast is completely digital. Digital television (DTV) is the transmission of television signals using digital rather than conventional analog methods. A set-top box is a device that enables an analog television set to become both a user interface to the Internet and to receive and decode digital television (DTV) broadcasts.

DTV set-top boxes (also known as receivers) are required for television viewers to enable their current analog television sets to receive digital broadcasts. Digital television set-top boxes are used in a variety of applications, namely for satellite, cable, and terrestrial DTV services. It is estimated that 35 million homes will use digital set-top boxes by the end of 2006, the estimated year for ending the transition to DTV.

Typically, a digital set-top box contains one or more microprocessors for running its operating system, e.g., LINUX™ or WINDOWS CE™, and for parsing the MPEG transport stream. A set-top box also includes RAM, an MPEG decoder chip, and other chips for audio decoding and processing. The contents of a set-top box depend on the DTV standard used. More sophisticated set-top boxes contain a hard drive for storing recorded television broadcasts, for downloaded software, and for other applications provided by the DTV service provider.

Often, there are a multitude of other devices connected to television sets in a variety of configurations, including digital video recorders, DVD players, standard cable boxes, etc.

If there are multiple television sets in a household, there may be circumstances in which a user desires to be reminded of a programming event regardless of which television set was used to create the reminder.

Accordingly, a need exists for a system and method for efficiently, effectively and flexibly allowing a user to customize a programming event reminder to desired television sets in a convenient manner.

### SUMMARY OF THE INVENTION

The present invention permits users to control and customize a reminder feature for reminding the user of an upcoming programming event(s). A reminder customizer feature according to the present invention may be implemented in any instrument (e.g., a receiver for a satellite television system, cable receivers, non-receiver devices, etc.) and provides users with the ability to select the device(s) (e.g., television set) on which a reminder is to appear.

In one aspect, a method for customizing a reminder for a programming event is provided comprising the steps of providing a reminder customizer on a first instrument, wherein the reminder customizer includes a reminder options feature which permits a user to indicate at least one of a plurality of devices on which the reminder is to appear.

In another aspect, a method for customizing a reminder for a programming event is provided comprising the steps of providing a reminder customizer on a set top box and providing a user interface for interactive communication with said reminder customizer, wherein said user interface provides a reminder options feature to permit a user to indicate at least one of a plurality of devices, capable of displaying the programming event, on which the reminder is to appear.

In yet another aspect, an apparatus for customizing a reminder for a programming event is provided comprising a reminder customizer which includes a reminder options feature for permitting a user to select at least one device for displaying a reminder at that device. A controller is provided for controlling coupling of a decoded signal to at least one device in accordance with the user-selected reminder options.

These, and other aspects, features and advantages of the present invention will be described or become apparent from the following detailed description of the preferred embodiments, which is to be read in connection with the accompanying drawings.

### BRIEF DESCRIPTION OF THE DRAWINGS

In the drawings, wherein like reference numerals denote similar elements throughout the views:

FIG. 1 illustrates an exemplary schematic illustration of a system having a reminder customizer according to an aspect of the present invention.

FIG. 2 illustrates an exemplary schematic illustration of a network system wherein each instrument includes a reminder customizer according to an alternate embodiment of the present invention.

FIG. 3 is an exemplary user interface for customizing a programming event reminder according to an aspect of the present invention.

FIG. 4 illustrates an exemplary flowchart of a method for customizing a programming event reminder according to an aspect of the present invention.

It should be understood that the drawings are for purposes of illustrating the concepts of the invention and are not necessarily the only possible configurations for illustrating the invention.

### DETAILED DESCRIPTION OF THE INVENTION

The present invention provides a system and method for allowing users to control and customize the setting of a reminder feature in an instrument (e.g., a receiver) for reminding the user of an upcoming programming event(s). The instrument may comprise, e.g., a set-top box for a satellite television system, a cable box in a cable system, a digital video recorder, or any receiver or non-receiver devices. A reminder options feature is provided for users to select the device(s) on which a reminder is to appear. A system according to one embodiment of the present invention includes an instrument for receiving e.g., video/audio signals which is connected (e.g., via physical or wireless connections either directly or indirectly) to at least one of a plurality of devices (e.g., television sets, displays, and/or other devices). Alternatively, the present invention may be implemented in a system comprising a plurality of instruments, each connected (physically/wirelessly, directly/indirectly) to at least one device.

It is to be noted that a reminder feature according to the present invention may be incorporated in any instrument (e.g., a digital video recorder, set top box, etc.) which may or may not function as a signal decoder (e.g., a signal may be decoded by a cable or satellite box and then fed into the digital video recorder having a remind timer option).

It should be understood that the elements shown in the FIGS. may be implemented in various forms of hardware, software or combinations thereof. Preferably, these elements are implemented in software on one or more appropriately programmed general-purpose devices, which may include a processor, memory and input/output interfaces.

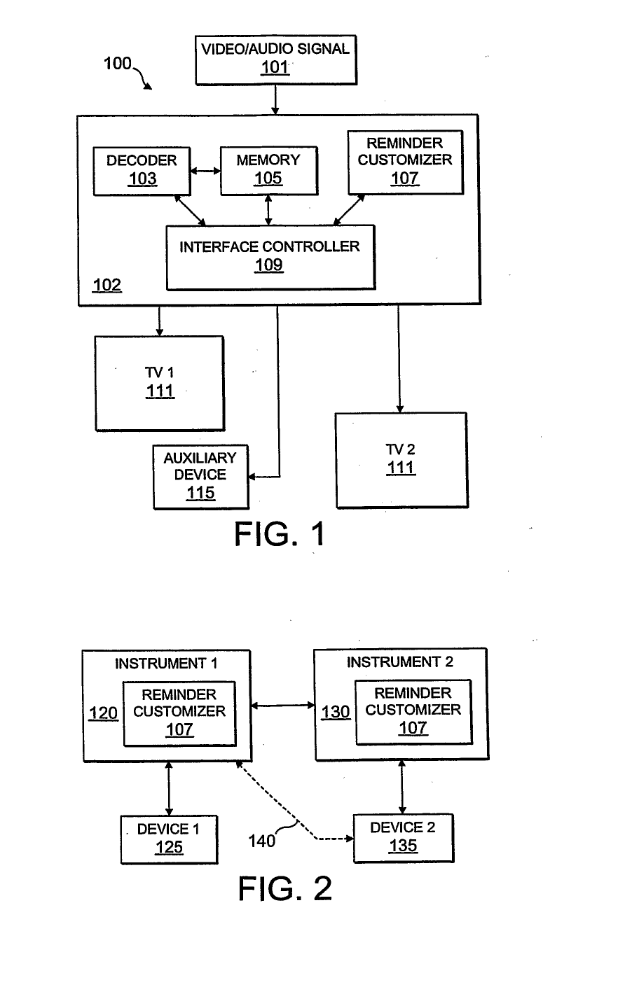

Referring now to the Figures, FIG. 1 illustrates an exemplary schematic illustration of a system 100 including an instrument 102 in communication with multiple devices, e.g., TV 1 (111), TV 2 (113) and an auxiliary device 115. The auxiliary device 115 may comprise any device capable of wired and/or wireless communication with the receiver 102, e.g., a phone, cell phone, beeper, PDA device, desktop or laptop computer, etc. and is preferably enabled to allow user interaction and communication with the receiver 102. It is to be noted that the auxiliary device(s) may be in wireless communication with and/or physically connected to the instrument 102.

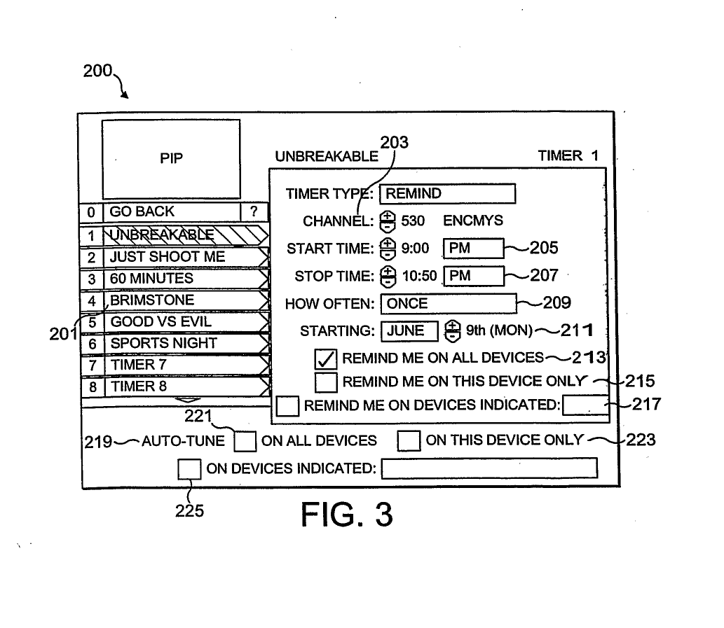

In a preferred embodiment as shown in FIG. 1 for exemplary purposes only, instrument 102 comprises a receiver and thus includes a decoder 103 for decoding an audio/video (A/V) signal 101, as well as a memory 105 and an interface controller 109 which are all operably connected to one another as shown in FIG. 1. A reminder customizer 107 is provided operably connected to the interface controller 109 according to an aspect of the present invention. The interface controller 109 controls coupling of decoded signals to any of the devices connected to the instrument 102 (here, e.g., television sets 11 1 and 113 and an auxiliary device 115) in accordance with/depending on, e.g., the user-specified reminder options selected, if any. The process of selecting/inputting reminder options is described in further detail in FIG. 3 below. The instrument 102 may include other features/components as known in the art (e.g., microprocessors, an operating system) using protocols as known in the art.

It is to be noted that the reminder customizer 107 of the present invention may be implemented in any instrument (e.g., regardless of whether that instrument functions as a signal decoder).

FIG. 2 illustrates an exemplary schematic illustration of a network system, according to an alternate embodiment of the present invention. In this embodiment, a plurality of instruments (e.g., instrument 1 (120) and instrument 2 (130)) may be provided each having the reminder customizer 107. Each of said plurality of instruments 120 and 130 are preferably in communication with each other as well as with at least one output device (e.g., instrument 120 communicates with device 125; instrument 130 communicates with device 135). It is to be noted that each instrument 120 and/or 130 may be enabled to communicate (e.g., wirelessly) directly with other devices to which it is not physically connected, e.g., as shown by arrow 140. Alternatively, each instrument may communicate indirectly with a device, e.g., instrument 120 may indirectly communicate with device 135 via instrument 130. In a preferred embodiment, instruments 120 and/or 130 may comprise receivers.

According to an aspect of the present invention, a user may set a remind timer option in receiver 120 to request that a reminder appear on either device 125 and/or device 135.

A user interface 200 is preferably provided which the user may access using any device (e.g., television set, PDA) operably connected to the instrument 102. FIG. 3 illustrates an exemplary user interface 200 comprising, e.g., a set-up screen with which the user may input/select information relating to e.g., the program(s) (e.g., television programming events) they wish to be reminded of. Such information may include various remind timer titles 201, program channel 203, program start time 205, program end time 207, frequency of reminders desired 209 arid start date for a reminder(s) 211. In one embodiment, when a remind timer title 201 is selected, the information in items 203, 205 and 207 is automatically set to the channel(s), date(s) and time period(s) corresponding to the selected remind timer title. In another embodiment, a user may manually input such data according to the program desired.

According to an aspect of the invention, the reminder customizer 107 provides a reminder options feature (via e.g., the set-up screen 200) for permitting a user to indicate the device(s) in which the user desires a program reminder to appear. The reminder options feature may be facilitated via various inputs which may comprise, e.g., a check-off box for setting a reminder for all devices 213 (e.g., TV's, cell phone, etc.), a box for setting the reminder to appear only on the device in which the reminder is being created 215, and/or a box for setting the reminder(s) to appear only on the device(s) indicated 217. Advantageously, this provides the user with the ability to select the exact device(s) on which the user wishes to have the program reminder appear on. It is to be noted that the device(s) on which the reminder is designated to appear on may or may not be a device capable of actually displaying the programming event.

The device location at which a user desires a reminder to appear often depends on the type of program that a user wants to be reminded of. As such, the flexibility and customization of reminder options facilitated by the present invention is particularly advantageous. For example, in situations such as when a user purchases a pay-per-view program and wishes to be reminded on every device connected to the instrument 102, the user may select box 213. There may be other situations where a user does not want to be reminded of an upcoming program in a location other than that which was used to create the reminder, e.g., if an adult user sets up a reminder for an upcoming “R-rated” movie, the user might not want to be reminded of that event on the living room television that is also accessible by the children of the household. In this situation, box 215 may be selected. If there are particular devices the user wishes to be reminded on, the user may select box 217 and manually input them or box 217 may enable a menu of available devices which may be selected individually by the user.

The present invention may also include an “auto-tune” feature 219 for automatically setting the appropriate television (which is set to display the reminder as per the user's inputs) to the appropriate channel at the time/day the “reminded-of” program is on. For example, the user may be presented with check-off boxes (as shown in FIG. 3) for designating that the auto-tune be performed on all devices 221, on the device used for creating the reminder only 223, or on a user-specified device(s) 225.

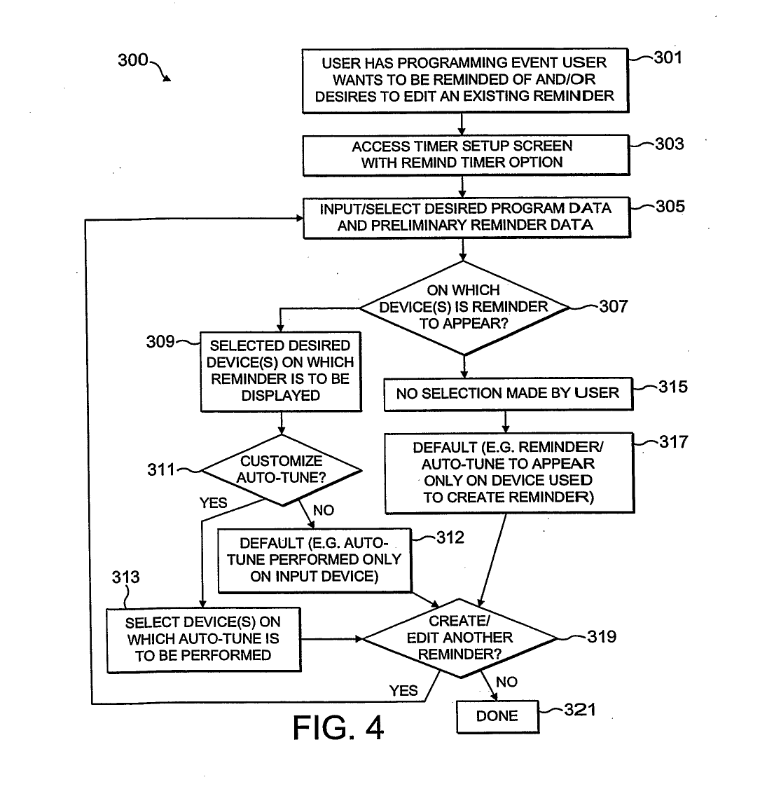

It is to be noted that various user-specified and/or factory-specified default mode(s) may be programmed by the user to activate if, e.g., the user fails to select any of the check-off boxes to specify the reminder options or auto-tune feature, as explained further below with reference to FIG. 4.

FIG. 4 depicts an exemplary flowchart 300 of a method of creating/editing a programming event reminder according to an aspect of the present invention. In step 301, a user desires to be reminded of at least one programming event and/or desires to edit an existing reminder(s). It is to be noted that the term “programming event” may refer to, e.g., any broadcast television program.

In step 303, the user accesses a set-up screen (e.g., set-up screen 200) and inputs/selects the program data as desired as well as “preliminary reminder” data (e.g., reminder frequency and reminder start date). In decision box 307, the user is presented with a reminder options feature, e.g., the option of selecting the device(s) on which the reminder is to be displayed. Such device(s) may comprise e.g., not only television sets, but PDAs, cell phones, landline phones, etc. which may be in wireless communication with and/or physically connected to the receiver.

In step 309, the user may enter/select the desired device on which the reminder is desired to be displayed. In decision box 311, the user is presented with the option to customize the auto-tune feature (e.g., so that the program for which the reminder is created is automatically tuned to at the designated time and date) on the desired device(s). The user may then enter/select the desired customized auto-tune features (step 313). In step 312, if no selection is made, the system may go into a default auto-tune mode (e.g., wherein the auto-tune is performed only on the input device). It is to be noted that the default mode may be altered by the user as desired to have the auto-tune feature be performed on any device(s) as desired, or alternatively, not be performed at all.

In step 315, if no selection is made by the user on which the reminder is desired to appear on, the system may go into a default reminder/auto-tune mode (step 317). For example, the default reminder mode may comprise wherein the reminder and auto-tune will appear only on the device used to create the reminder. It is to be noted that this default mode may be altered by the user as desired to have, e.g., the reminder/auto-tune features be performed on any device(s).

In decision box 319, the user is presented with the option of creating another reminder. If yes, the method returns to step 305. If no, the user is done (step 321).

Although the embodiment which incorporates the teachings of the present invention has been shown and described in detail herein, those skilled in the art can readily devise many other varied embodiments that still incorporate these teachings. Having described preferred embodiments for a system and method with the ability to permit users to customize reminder features for programming events (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A method for customizing a reminder for a programming event comprising the steps of:
providing a reminder customizer on a first instrument, wherein the reminder customizer includes a reminder options feature, which permits a user to indicate at least one of a plurality of devices on which the reminder is to appear.

2. The method of claim 1, further comprising the step of providing a second instrument, said second instrument being in communication with said first instrument, wherein said at least one indicated device on which the reminder is to appear is operably connected to said second instrument.

3. The method of claim 1, wherein the reminder customizer further includes a customizable auto-tune feature which permits the user to specify that the programming event for which the reminder is created is automatically tuned to at a designated time and date and on a desired device.

4. The method of claim 1, wherein if the user does not indicate the device on which the reminder is to appear, further comprising the step of activating a default mode.

5. The method of claim 4, wherein the default mode is customizable by the user.

6. The method of claim 1, wherein the device comprises at least one of a television, PDA, computer, cellular phone and landline phone.

7. The method of claim 1, wherein the first instrument, comprises a receiver.

8. A method for customizing a reminder for a programming event comprising the steps of:
providing a reminder customizer on a set top box;
providing a user interface for interactive communication with said reminder customizer, said user interface providing a reminder options feature to permit a user to indicate at least one of a plurality of devices, capable of displaying the programming event, on which the reminder is to appear.

9. The method of claim 8, further comprising the step of providing a second instrument, said second instrument being in communication with said set top box, wherein said selected device on which the reminder is to appear is operably connected to said second instrument.

10. The method of claim 8, wherein the reminder customizer further includes a customizable auto-tune feature which permits the user to specify that the programming event for which the reminder is created is automatically tuned to at a designated time and date and on a desired device.

11. The method of claim 8, wherein if the user does not indicate the device on which the reminder is to appear, further comprising the step of activating a default mode.

12. The method of claim 11, wherein the default mode is customizable by the user.

13. The method of claim 8, wherein the device comprises at least one of a television, PDA, computer, cellular phone and landline phone.

14. An apparatus for customizing a reminder for a programming event comprising:
a reminder customizer which includes a reminder options feature for permitting a user to select at least one device for displaying a reminder at that device; and
a controller for controlling coupling of a decoded signal to at least one device in accordance with the user-selected reminder options.

15. The apparatus of claim 14, further comprising a decoder for providing the decoded signal from an input signal.

16. The apparatus of claim 14, wherein the reminder customizer further includes a customizable auto-tune feature which permits the user to specify that the programming event for which the reminder is created is automatically tuned to at a designated time and date and on a desired device.

17. The apparatus of claim 14, wherein the device comprises at least one of a television, PDA, computer, cellular phone and landline phone.
